(19) United States
(12) Patent Application Publication
(10) Pub. No.: US 2023/0093264 A1
(43) Pub. Date: Mar. 23, 2023

(54) METHOD, DEVICE AND COMPUTER STORAGE MEDIUM FOR COMMUNICATION

(71) Applicant: NEC CORPORATION, Tokyo (JP)

(72) Inventors: Yukai GAO, Beijing (CN); Gang WANG, Beijing (CN)

(73) Assignee: NEC CORPORATION, Tokyo (JP)

(21) Appl. No.: 17/909,168

(22) PCT Filed: Mar. 4, 2020
(86) PCT No.: PCT/CN2020/077825

§ 371 Date: Sep. 2, 2022

(51) Int. Cl. H04W 52/16; H04W 72/12; H04L 5/00; H04L 1/08

(52) U.S. Cl. CPC H04W 52/16; H04W 72/1268; H04W 72/1289; H04L 5/0053; H04L 1/08; H04L 5/0092

(57) ABSTRACT

Embodiments of the present disclosure relate to methods, devices and computer storage media for communication. A method comprises generating, at a network device, downlink control information (DCI) indicating a plurality of transmission power control (TPC) commands for power control of transmissions from a terminal device to the network device; and transmitting, from the network device to the terminal device, the generated DCI for scheduling the transmissions from the terminal device to the network device. Embodiments of the present disclosure enable different power control adjustments for different beams.

### TECHNICAL FIELD

Embodiments of the present disclosure generally relate to the field of telecommunication, and in particular, to methods, devices and computer storage media for communication.

### BACKGROUND

In the 3GPP meeting RAN#86, enhancements on the support for multi-Transmission and Reception Point (multi-TRP) deployment have been discussed. For example, it has been proposed to identify and specify features to improve reliability and robustness for channels (such as, Physical Downlink Control Channel (PDCCH), Physical Uplink Shared Channel (PUSCH) and/or Physical Uplink Control Channel (PUCCH)) other than Physical Downlink Shared Channel (PDSCH) using multi-TRP and/or multi-panel with Release 16 reliability features as a baseline. It has also been proposed to identify and specify features to enable inter-cell multi-TRP operations. It has also been proposed to evaluate and specify enhancements for simultaneous multi-TRP transmissions with multi-panel receptions.

For uplink transmissions, if repetitions for an uplink channel (such as, PUSCH or

PUCCH) are enabled for reliability and/or robustness, the repetitions may be transmitted via different beams associated with different TRPs or antenna panels. The propagation environments associated with different TRPs or antenna panels may be different. In this event, the power control adjustments for different repetitions should be different. However, in current 3GPP specifications, only a single power control adjustment value is supported for an uplink channel. Moreover, in current 3GPP specifications, there is no detail on the configuration about repetitions for PDCCH, PUCCH and/or PUSCH.

### SUMMARY

In general, example embodiments of the present disclosure provide methods, devices and computer storage media for communication.

In a first aspect, there is provided a method of communication. The method comprises generating, at a network device, downlink control information (DCI) indicating a plurality of transmission power control (TPC) commands for power control of transmissions from a terminal device to the network device; and transmitting, from the network device to the terminal device, the generated DCI for scheduling the transmissions from the terminal device to the network device.

In a second aspect, there is provided a method of communication. The method comprises receiving, at a terminal device and from a network device, downlink control information (DCI) indicating a plurality of transmission power control (TPC) commands for power control of transmissions from the terminal device to the network device; determining the plurality of TPC commands from the DCI; and performing the transmissions from the terminal device to the network device while controlling power of the transmissions based on the plurality of TPC commands.

In a third aspect, there is provided a method of communication. The method comprises transmitting, from a network device to a terminal device, a configuration about repetitions for a physical channel between the network device and the terminal device; and communicating the repetitions for the physical channel with the terminal device based on the configuration.

In a fourth aspect, there is provided a method of communication. The method comprises receiving, at a terminal device and from a network device, a configuration about repetitions for a physical channel between the network device and the terminal device; and communicating the repetitions for the physical channel with the network device based on the configuration.

In a fifth aspect, there is provided a network device. The network device comprises a processor and a memory coupled to the processor. The memory stores instructions that when executed by the processor, cause the network device to perform the method according to the first aspect of the present disclosure.

In a sixth aspect, there is provided a terminal device. The terminal device comprises a processor and a memory coupled to the processor. The memory stores instructions that when executed by the processor, cause the terminal device to perform the method according to the second aspect of the present disclosure.

In a seventh aspect, there is provided a network device. The network device comprises a processor and a memory coupled to the processor. The memory stores instructions that when executed by the processor, cause the network device to perform the method according to the third aspect of the present disclosure.

In an eighth aspect, there is provided a terminal device. The terminal device comprises a processor and a memory coupled to the processor. The memory stores instructions that when executed by the processor, cause the terminal device to perform the method according to the fourth aspect of the present disclosure.

In a ninth aspect, there is provided a computer readable medium having instructions stored thereon. The instructions, when executed on at least one processor, cause the at least one processor to perform the method according to the above first, second, third or fourth aspect of the present disclosure.

In a tenth aspect, there is provided a computer program product that is stored on a computer readable medium and includes machine-executable instructions. The machine-executable instructions, when being executed, cause a machine to perform the method according to the above first, second, third or fourth aspect of the present disclosure.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A and FIG. 1B illustrate an example communication network in which embodiments of the present disclosure can be implemented;

FIG. 2 illustrates a signaling chart of an example process of communication in accordance with some embodiments of the present disclosure;

FIG. 3 illustrates an example of embodiments of the present disclosure;

FIG. 4 illustrates an example of embodiments of the present disclosure;

FIG. 5 illustrates a flowchart of an example method in accordance with some embodiments of the present disclosure;

FIG. 6 illustrates a flowchart of an example method in accordance with some embodiments of the present disclosure;

FIG. 7 illustrates a flowchart of an example method in accordance with some embodiments of the present disclosure;

FIG. 8 illustrates a flowchart of an example method in accordance with some embodiments of the present disclosure; and

FIG. 9 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments’ and ‘an embodiment’ are to be read as ‘at least some embodiments.’ The term ‘another embodiment’ is to be read as ‘at least one other embodiment.’ The terms ‘first,’ and the like may refer to different or same objects. Other definitions, explicit and implicit, may be included below.

In some examples, values, procedures, or apparatus are referred to as ‘best,’ ‘lowest,’ highest,“minimum,”maximum,' or the like. It will be appreciated that such descriptions are intended to indicate that a selection among many used functional alternatives can be made, and such selections need not be better, smaller, higher, or otherwise preferable to other selections.

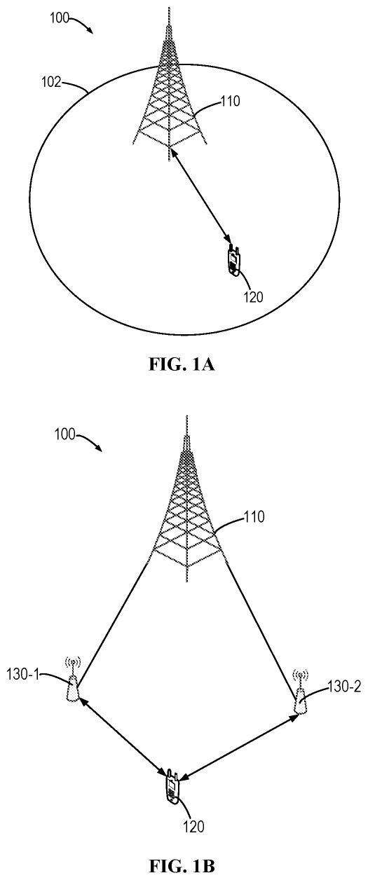

FIG. 1A shows an example communication network 100 in which embodiments of the present disclosure can be implemented. The network 100 includes a network device 110 and a terminal device 120 served by the network device 110. The network 100 may provide one or more serving cells 102 to serve the terminal device 120. It is to be understood that the number of network devices, terminal devices and/or serving cells is only for the purpose of illustration without suggesting any limitations to the present disclosure. The network 100 may include any suitable number of network devices, terminal devices and/or serving cells adapted for implementing implementations of the present disclosure.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. For the purpose of discussion, in the following, some embodiments will be described with reference to UE as an example of the terminal device 120.

As used herein, the term ‘network device’ or ‘base station’ (BS) refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

In one embodiment, the terminal device 120 may be connected with a first network device and a second network device (not shown in FIG. 1A). One of the first network device and the second network device may be in a master node and the other one may be in a secondary node. The first network device and the second network device may use different radio access technologies (RATs). In one embodiment, the first network device may be a first RAT device and the second network device may be a second RAT device. In one embodiment, the first RAT device may be an eNB and the second RAT device is a gNB. Information related to different RATs may be transmitted to the terminal device 120 from at least one of the first network device and the second network device. In one embodiment, first information may be transmitted to the terminal device 120 from the first network device and second information may be transmitted to the terminal device 120 from the second network device directly or via the first network device. In one embodiment, information related to configuration for the terminal device configured by the second network device may be transmitted from the second network device via the first network device. Information related to reconfiguration for the terminal device configured by the second network device may be transmitted to the terminal device from the second network device directly or via the first network device. The information may be transmitted via any of the following: Radio Resource Control (RRC) signaling, Medium Access Control (MAC) control element (CE) or Downlink Control Information (DCI).

In the communication network 100 as shown in FIG. 1, the network device 110 can communicate data and control information to the terminal device 120 and the terminal device 120 can also communication data and control information to the network device 110. A link from the network device 110 to the terminal device 120 is referred to as a downlink (DL), while a link from the terminal device 120 to the network device 110 is referred to as an uplink (UL).

In some embodiments, for downlink transmissions, the network device 110 may transmit control information via a PDCCH and/or transmit data via a PDSCH to the terminal device 120. Additionally, the network device 110 may transmit one or more reference signals (RSs) to the terminal device 120. The RS transmitted from the network device 110 to the terminal device 120 may also referred to as a “DL RS”. Examples of the DL RS may include but are not limited to Demodulation Reference Signal (DMRS), Channel State Information-Reference Signal (CSI-RS), Sounding Reference Signal (SRS), Phase Tracking Reference Signal (PTRS), fine time and frequency Tracking Reference Signal (TRS) and so on.

In some embodiments, for uplink transmissions, the terminal device 120 may transmit control information, a Channel State Information (CSI) feedback, a Layer-1 Reference Signal Received Power (L1-RSRP) feedback, a Layer-1 Signal-to-Noise and Interference Ratio (L1-SINR) feedback, and/or a positive acknowledgement (ACK) or negative acknowledgement (NACK) feedback via a PUCCH to the network device 110. The terminal device 120 may transmit data via a PUSCH to the network device 110. Additionally, the terminal device 120 may transmit one or more RSs to the network device 110. The RS transmitted from the terminal device 120 to the network device 110 may also referred to as a “UL RS”. Examples of the UL RS may include but are not limited to DMRS, CSI-RS, SRS, PTRS, fine time and frequency TRS and so on.

The communications in the network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

The network device 110 (such as, a gNB) may be equipped with one or more TRPs or antenna panels. As used herein, the term “TRP” refers to an antenna array (with one or more antenna elements) available to the network device located at a specific geographical location. For example, a network device may be coupled with multiple TRPs in different geographical locations to achieve better coverage. The one or more TRPs may be included in a same serving cell or different serving cells.

It is to be understood that the TRP can also be a panel, and the panel can also refer to an antenna array (with one or more antenna elements). Although some embodiments of the present disclosure are described with reference to multiple TRPs for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

FIG. 1B shows an example scenario of the network 100 as shown in FIG. 1A. As shown in FIG. 1B, for example, the network device 110 may communicate with the terminal device 120 via TRPs 130-1 and 130-2. In the following text, the TRP 130-1 may be also referred to as the first TRP, while the TRP 130-2 may be also referred to as the second TRP. The first and second TRPs 130-1 and 130-2 may be included in a same serving cell (such as, the cell 102 as shown in FIG. 1A) or different serving cells provided by the network device 110. Although some embodiments of the present disclosure are described with reference to the first and second TRPs 130-1 and 130-2 within a same serving cell provided by the network device 110, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

As described above, in the 3GPP meeting RAN#86, enhancements on the support for multi-TRP deployment have been discussed. For example, it has been proposed to identify and specify features to improve reliability and robustness for channels (such as, PDCCH, PUSCH and/or PUCCH) other than PDSCH using multi-TRP and/or multi-panel with Release 16 reliability features as a baseline. It has also been proposed to identify and specify features to enable inter-cell multi-TRP operations. It has also been proposed to evaluate and specify enhancements for simultaneous multi-TRP transmissions with multi-panel receptions.

For uplink transmissions, if repetitions for an uplink channel (such as, PUSCH or PUCCH) are enabled for reliability and/or robustness, the repetitions may be transmitted via different beams, and/or based on different spatial relation information, different Transmission Configuration Indicator (TCI) states or different quasi co-location (QCL) parameters. For example, the different beams, the different spatial relation information, the different TCI states and/or the different QCL parameters may be associated with different TRPs or antenna panels. The propagation environments associated with different TRPs or antenna panels may be different. In this event, the power control adjustments for different repetitions should be different. However, in current 3GPP specifications, only a single power control adjustment value is supported for an uplink channel.

Embodiments of the present disclosure provide a solution to solve the above problem and/or one or more of other potential problems. This solution enables different power control adjustments for different PUSCH or PUCCH repetitions.

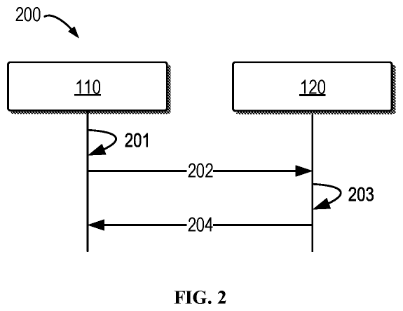

FIG. 2 illustrates a signaling chart of an example process 200 of communication in accordance with some embodiments of the present disclosure. The process 200 involves the network device 110 and the terminal device 120 as shown in FIG. 1A and/or FIG. 1B.

As shown in FIG. 2, the network device 110 generates (201) DCI indicating a plurality of TPC commands for power control of transmissions from the terminal device 120 to the network device 110. In some embodiments, the transmissions may be PUSCH repetitions or PUCCH repetitions. The network device 110 transmits (202) the generated DCI to the terminal device 120. In response to receiving the DCI, the terminal device 120 determines (203) the plurality of TPC commands from the DCI. Then, the terminal device transmits (204) the PUSCH repetitions or the PUCCH repetitions to the network device 110 while controlling/adjusting transmission power of the PUSCH repetitions or the PUCCH repetitions based on the plurality of TPC commands.

In some embodiments, if PUSCH or PUCCH repetitions to be transmitted via different beams, and/or based on different spatial relation information, different TCI states or different QCL parameters are enabled, the DCI for scheduling the PUSCH or PUCCH repetitions may indicate a plurality of TPC commands and each TPC command may be applied to at least one corresponding PUSCH or PUCCH repetition.

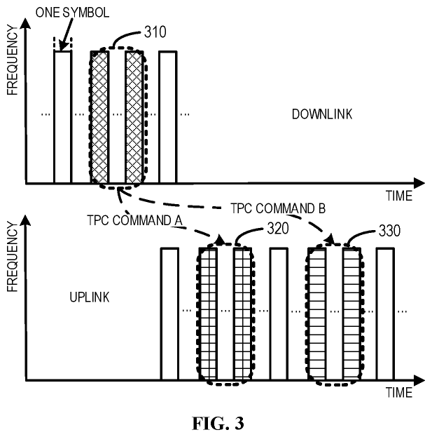

FIG. 3 illustrates an example of such embodiments. As shown in FIG. 3, for example, the network device 110 may transmit DCI 310 to the terminal device 120 for scheduling UL transmissions 320 and 330 (for example, repetitions for PUSCH or PUCCH) from the terminal device 120 to the network device 110. For example, the UL transmissions 320 and 330 may be associated with different beams, different spatial relation information, different TCI states or different QCL parameters. In some embodiments, the DCI 310 may indicate TPC commands A and B, where the TPC command A is to be applied to the UL transmission 320 and the TPC command B is to be applied to the UL transmission 330.

In some embodiments, the DCI for scheduling the PUSCH or PUCCH repetitions may include a plurality of fields for indicating the plurality of TPC commands. For example, in some embodiments, the DCI for scheduling the PUSCH or PUCCH repetitions may include a first field (for example, 2 bits) for indicating a first TPC command associated with a first power control adjustment state/and a second field (for example, 2 bits) for indicating a second TPC command associated with a second power control adjustment state 1−l, where l ϵ {0, 1}. The value of l can be configured l provided to the terminal device 120 as legacy solutions. For another example, in some embodiments, the DCI for scheduling the PUSCH or PUCCH repetitions may include a first field (for example, 2 bits) for indicating a first TPC command associated with a first power control adjustment state 0 and a second field (for example, 2 bits) for indicating a second TPC command associated with a second power control adjustment state 1.

Regarding the power control adjustment for PUSCH, as specified in the 3GPP specification TS 38.213 clause 7.1.1, if the UE is configured with twoPUSCH-PC-AdjustmentStates, then l ϵ {0, 1}; and if the UE is not configured with twoPUSCH-PC-AdjustmentStates or if the PUSCH transmission is scheduled by a Random Access Response (RAR) UL grant, l=0. For a PUSCH (re)transmission configured by ConfiguredGrantConfig, the value of l ϵ {0, 1} is provided to the UE by powerControlLoopToUse. If the UE is provided with SRI-PUSCH-PowerControl, the UE obtains a mapping between a set of values for the SRI field in DCI format 0_1 and the value(s) of l provided by sri-PUSCH-ClosedLoopIndex. If the PUSCH transmission is scheduled by DCI format 0_1 and if the DCI format 0_1 includes an SRI field, the UE determines the value of l that is mapped to the value of the SRI field. If the PUSCH transmission is scheduled by DCI format 0_0 or by DCI format 0_1 that does not include an SRI field, or if the UE is not provided with SRI-PUSCH-PowerControl, l=0. If the UE obtains one TPC command from DCI format 2_2 with CRC scrambled by a TPC-PUSCH-RNTI (TPC-PUSCH-Radio Network Temporary Identifier), the value of l is provided by the closed loop indicator field in DCI format 2_2.

Regarding the power control adjustment for PUCCH, as specified in the 3GPP specification TS 38.213 clause 7.2.1, if the UE is provided twoPUCCH-PC-AdjustmentStates and PUCCH-SpatialRelationInfo, then l ϵ {0, 1}; and if the UE is not provided with twoPUCCH-PC-AdjustmentStates or PUCCH-SpatialRelationInfo, l=0. If the UE obtains a TPC command value from DCI format 1_0 or DCI format 1_1 and if the UE is provided with PUCCH-SpatialRelationInfo, the UE obtains a mapping, by an index provided by p0-PUCCH-Id, between a set of pucch-SpatialRelationInfoId values and a set of values for closedLoopIndex that provide the value(s) of l. If the UE receives an activation command indicating a value of pucch-SpatialRelationInfoId, the UE determines the value closedLoopIndex that provides the value of l through the link to a corresponding p0-PUCCH-Id index. If the UE obtains one TPC command from DCI format 2_2 with CRC scrambled by a TPC-PUCCH-RNTI, the value of l is provided by the closed loop indicator field in DCI format 2_2.

In some embodiments, the DCI for scheduling the PUSCH or PUCCH repetitions may include an SRI field or a TCI field for indicating the plurality of TPC commands. In some embodiments, the additional TPC command(s) may be jointly encoded with the SRI field. Table 1A illustrates example values of the SRI field according to some embodiments of the present disclosure. In Table 1A, up to two SRS resources (indexed with ‘0’ and ‘1’) are configured for PUSCH transmissions.

TABLE 1A
Example values of the SRI field

| Value of | Indicated SRS resource(s) |
|---|---|
| the SRI field | and/or TPC command value |
| 0 | SRS resource 0 |
| 1 | SRS resource 1 |
| 2 | SRS resources 0 and 1 (for example, for two |
| | transmission layers of a PUSCH) |
| 3 | SRS resources 0 and 1 for PUSCH repetitions (for |
| | example, each PUSCH repetition is |
| | transmitted with one transmission layer); and |
| | TPC command value 0. |
| 4 | SRS resources 0 and 1 for PUSCH repetitions (for |
| | example, each PUSCH repetition is |
| | transmitted with one transmission layer); and |
| | TPC command value 1. |
| 5 | SRS resources 0 and 1 for PUSCH repetitions (for |
| | example, each PUSCH repetition is |
| | transmitted with one transmission layer); and |
| | TPC command value 2. |
| 6 | SRS resources 0 and 1 for PUSCH repetitions (for |
| | example, each PUSCH repetition is |
| | transmitted with one transmission layer); and |
| | TPC command value 3. |

In some embodiments, there may be K values for the SRI or TCI field, where K is an integer and 1≤K≤8, for example, K=4. In some embodiments, the K values may indicate same SRS resources or same TCI states. For example, the K values may indicate same SRS resource indices, same SRS resource set indices, a same number of SRS resources, and/or same TCI state indices. Additionally, the K values may indicate different TPC command values. Table 1B illustrates example values of the SRI/TCI field according to some embodiments of the present disclosure. In Table 1B, 4 TPC command values can be used for PUSCH transmissions. For example, W is an integer and 0≤W≤63. SRS resource(s) Y may include one or more SRS resources and TCI state(s) Z may include one or more TCI states.

TABLE IB
Example values of the SRI/TCI field

| | Indicated SRS resource(s)/ |
|---|---|
| Value of the | TCI state(s) and TPC |
| SRI/TCI field | command value(s) |
| W | SRS resource(s) Y or TCI state(s) |
| | Z; and TPC command value 0. |
| W + 1 | SRS resource(s) Y or TCI state(s) |
| | Z; and TPC command value 1. |
| W + 2 | SRS resource(s) Y or TCI state(s) |
| | Z; and TPC command value 2. |
| W + 3 | SRS resource(s) Y or TCI state(s) |
| | Z; and TPC command value 3. |

In some embodiments, if PDCCH repetitions are enabled and if PUSCH or PUCCH repetitions to be transmitted via different beams, based on different spatial relation information, based on different TCI states or based on different QCL parameters are enabled, the network device 110 may transmit a plurality of repetitions of the DCI (that is, PDCCH repetitions) to the terminal device 120. The plurality of PDCCH repetitions may indicate a plurality of TPC commands respectively, which are to be applied to the PUSCH or PUCCH repetitions.

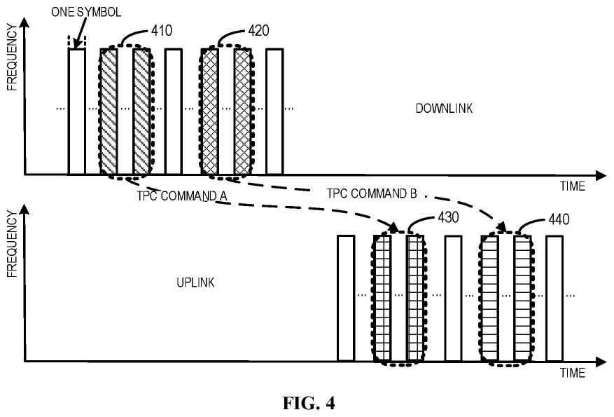

FIG. 4 illustrates an example of such embodiments. As shown in FIG. 4, for example, the network device 110 may transmit PDCCH repetitions 410 and 420 to the terminal device 120 for scheduling UL transmissions 430 and 440 (for example, repetitions for PUSCH or PUCCH) from the terminal device 120 to the network device 110. For example, the UL transmissions 430 and 440 may be associated with different beams, different spatial relation information, different TCI states or different QCL parameters. In some embodiments, the PDCCH repetition 410 may indicate a TPC command A and the PDCCH repetition 420 may indicate a TPC command B, where the TPC command A is to be applied to the UL transmission 430 and the TPC command B is to be applied to the UL transmission 440.

In some embodiments, N TPC commands may be indicated by the PDCCH repetitions, where N is an integer and 1≤N≤8. For example, N=2. Each of the N TPC commands may correspond to a power control adjustment state. In some embodiments, the power of an UL transmission can be controlled/adjusted by the terminal device 120 based on a corresponding TPC command and a corresponding power control adjustment state to be applied to the UL transmission. In one embodiment, a TPC command with an index n may correspond to a power control adjustment state l, where l=n mod 2 and n ϵ {0, 1 . . . N−1}. In one embodiments, a TPC command with an index n may correspond to a power control adjustment state (l+n mod 2) mod 2, where l can be determined based on legacy solutions as described above and n ϵ {0, 1 . . . N−1}. In one embodiments, a TPC command with an index n may correspond to a power control adjustment state l, where n ϵ {0, 1 . . . N−1} and l=0 if n<N/2, otherwise l=1. In one embodiment, a TPC command with an index n may correspond to a power control adjustment state l if n<N/2, otherwise the TPC command may correspond to a power control adjustment state 1−l, where l can be determined based on legacy solutions as described above and n ϵ {0, 1 . . . N−1}.

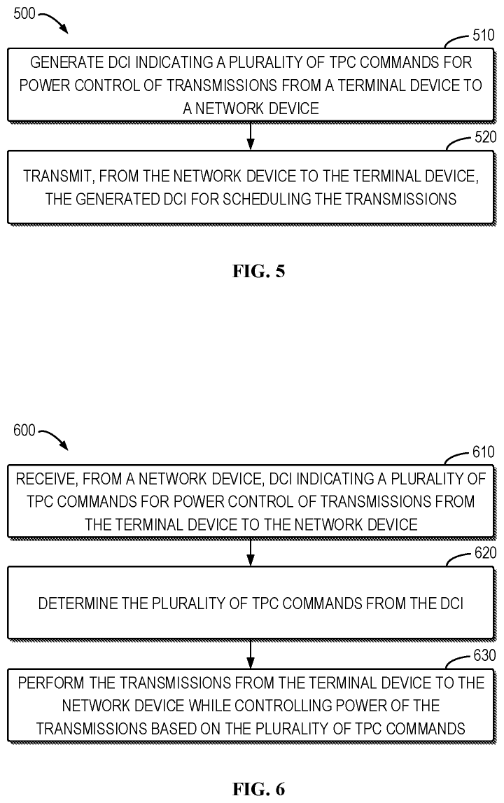

FIG. 5 illustrates a flowchart of an example method 500 in accordance with some embodiments of the present disclosure. The method 500 can be performed at the network device 110 as shown in FIG. 1A, FIG. 1B and/or FIG. 2. It is to be understood that the method 500 may include additional blocks not shown and/or may omit some blocks as shown, and the scope of the present disclosure is not limited in this regard.

At block 510, the network device 110 generates DCI indicating a plurality of TPC commands for power control of transmissions from the terminal device 120 to the network device 110.

In some embodiments, the network device 110 may generate the DCI comprising a plurality of fields for indicating the plurality of TPC commands.

In some embodiments, the network device 110 may generate the DCI comprising an SRS resource indicator (SRI) field or a transmission configuration indicator (TCI) field for indicating the plurality of TPC commands.

In some embodiments, the network device 110 may generate a plurality of repetitions of the DCI, the plurality of repetitions indicating the plurality of TPC commands respectively.

At block 520, the network device 110 transmits, to the terminal device 120, the generated DCI for scheduling the transmissions from the terminal device 120 to the network device 110.

In some embodiments, the transmissions scheduled by the generated DCI may comprise PUSCH transmissions or PUCCH transmissions.

FIG. 6 illustrates a flowchart of an example method 600 in accordance with some embodiments of the present disclosure. The method 600 can be performed at the terminal device 120 as shown in FIG. 1A, FIG. 1B and/or FIG. 2. It is to be understood that the method 600 may include additional blocks not shown and/or may omit some blocks as shown, and the scope of the present disclosure is not limited in this regard.

At block 610, the terminal device 120 receives, from the network device 110, DCI indicating a plurality of TPC commands for power control of transmissions from the terminal device 120 to the network device 110.

At block 620, the terminal device 120 determines the plurality of TPC commands from the DCI.

In some embodiments, the DCI may comprise a plurality of fields for indicating the plurality of TPC commands and the terminal device 120 may determine the plurality of TPC commands from the plurality of fields in the DCI.

In some embodiments, the DCI may comprise an SRI field or a transmission configuration indicator (TCI) field for indicating the plurality of TPC commands. The terminal device 120 may determine the plurality of TPC commands from the SRI field or the TCI field in the DCI.

In some embodiments, the terminal device 120 may receive a plurality of repetitions of the DCI from the network device 110 and determine the plurality of TPC commands from the plurality of repetitions respectively.

At block 630, the terminal device 120 performs the transmissions to the network device 110 while controlling power of the transmissions based on the plurality of TPC commands.

In some embodiments, the transmissions may comprise PUSCH transmissions or PUCCH transmissions.

In some embodiments, the terminal device 120 may determine, from the plurality of TPC commands, a TPC command to be used for controlling power of a transmission of the transmissions. The terminal device 120 may determine a power control adjustment state corresponding to the TPC command. Then, the terminal device 120 may control power of the transmission based on the power control adjustment state and the TPC command.

As described above, in current 3GPP specifications, there is no detail on the configuration about repetitions for PDCCH, PUCCH and/or PUSCH. Embodiments of the present disclosure provide a solution for configuring repetitions for PDCCH, PUCCH and/or PUSCH.

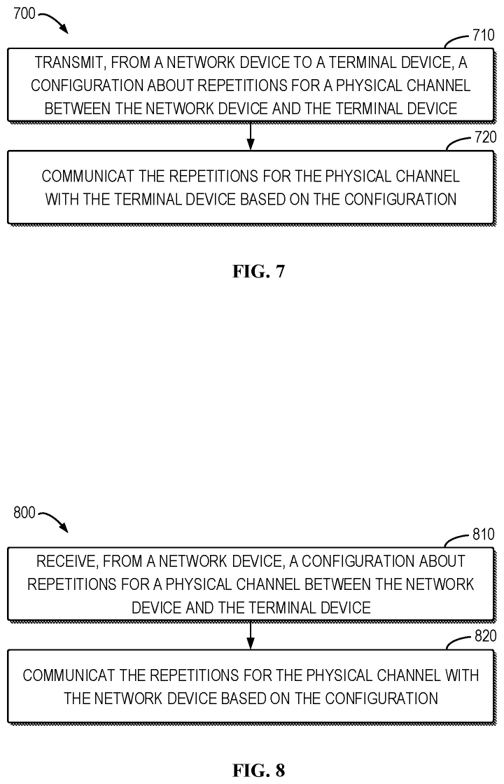

FIG. 7 illustrates a flowchart of an example method 700 in accordance with some embodiments of the present disclosure. The method 700 can be performed at the network device 110 as shown in FIG. 1A, FIG. 1B and/or FIG. 2. It is to be understood that the method 700 may include additional blocks not shown and/or may omit some blocks as shown, and the scope of the present disclosure is not limited in this regard.

At block 710, the network device 110 transmits, to the terminal device 120, a configuration about repetitions for a physical channel between the network device and the terminal device. At block 720, the network device 110 communicates the repetitions for the physical channel with the terminal device 120 based on the configuration.

In some embodiments, the physical channel may be a PDCCH and the configuration may indicate at least one of the following: whether PDCCH repetitions are enabled or not; a number of PDCCH repetitions; at least one Control Resource Set (CORESET) to be used for the PDCCH; and whether the PDCCH repetitions are used for scheduling transmissions of same data or same control information. For example, the configuration may be transmitted from the network device 110 to the terminal device 120 via any of the following: Radio Resource Control (RRC) signaling, Medium Access Control (MAC) control element (CE) or DCI.

In some embodiments, the configuration may indicate a CORESET configured with a plurality of QCL parameters and/or TCI states. The plurality of QCL parameters and/or TCI states may be divided into two sets, while one set may be applied to at least a part of the PDCCH repetitions and the other set may be applied to the rest part of the PDCCH repetitions. For example, if the number of the PDCCH repetitions is N_{r_pdcch}, where N_{r_pdcch} is a positive integer (for example, 2≤N_{r_pdcch}≤16), and if the CORESET is configured with two sets of QCL parameters and/or two TCI states, then one set of QCL parameters and/or one TCI state may be applied to floor (N_{r_pdcch}/2) or ceil (N_{r_pdcch}/2) PDCCH repetitions, and the other set of QCL parameters and/or the other TCI state may be applied to remaining PDCCH repetitions.

In some embodiments, the configuration may indicate a first CORESET (or a first search space) and a second CORESET (or a second search space). The first CORESET (or the first search space) may be applied to at least a part of the PDCCH repetitions and the second CORESET (or the second search space) may be applied to the rest part of the PDCCH repetitions. For example, if the number of the PDCCH repetitions is N_{r_pdcch}, where N_{r_pdcch} is a positive integer (for example, 2≤N_{r_pdcch}≤16), the first CORESET (or the first search space) may be applied to floor (N_{r_pdcch}/2) or ceil (N_{r_pdcch}/2) PDCCH repetitions and the second CORESET (or the second search space) may be applied to remaining PDCCH repetitions. In some embodiments, the two CORESETs or the two search spaces may be configured to be used for scheduling transmissions of same data.

In some embodiments, the physical channel may be a PUSCH and the configuration may indicate at least one of the following: whether PUSCH repetitions are enabled or not; a number of PUSCH repetitions; and a maximum number of layers for each PUSCH repetition. For example, the configuration may be transmitted from the network device 110 to the terminal device 120 via any of the following: RRC signaling, MAC CE or DCI.

In some embodiments, the network device 110 may transmit the configuration to the terminal device 120 via DCI. The DCI may include an SRI field for indicating SRS resource(s) to be used for PUSCH. In some embodiments, the value of the SRI field (also referred to as “SRI codepoint”) may indicate a plurality of SRS resources or SRS resource sets associated with different beams, different spatial relation information or different QCL parameters. The PUSCH repetitions may be transmitted from the terminal device 120 to the network device 110 via the different beams or based on the different spatial relation information or the different QCL parameters. For example, if the number of the PUSCH repetitions is N_{r_pusch}, where N_{r_pusch} is a positive integer (for example, 1≤N_{r_pusch}≤16) and if one SRI codepoint is associated with first spatial relation information and second spatial relation information, the first spatial relation information may be applied to floor (N-_{r_pusch}/2) or ceil (N_{r_pusch}/2) PUSCH repetitions and the second spatial relation information may be applied to remaining PUSCH repetitions.

Table 2A illustrates example values of the SRI field according to some embodiments of the present disclosure. In Table 2A, up to two SRS resources (indexed with ‘0’ and ‘1’) associated with different beams or different spatial relation information are to be used for PUSCH transmissions.

TABLE 2A
Example values of the SRI field

| Value of | |
|---|---|
| the SRI field | Indicated SRS resource(s) |
| 0 | SRS resource 0 |
| 1 | SRS resource 1 |
| 2 | SRS resources 0 and 1 for two |
| | transmission layers of a PUSCH |
| 3 | SRS resources 0 and 1 |
| | for PUSCH repetitions |

In some embodiments, there may be K values for the SRI or TCI field, where K is an integer and for example, 1≤K≤8, for example, K=2. In some embodiments, the K values may indicate same SRS resources or same TCI states. For example, the K values may indicate same SRS resource indices, same SRS resource set indices, a same number of SRS resources, and/or same TCI state indices. For example, each of the K values may also indicate a different number of transmission layers for a PUSCH. For another example, each of the K values may also indicate whether PUSCH repetitions are enabled or disabled. For another example, each of the K values may also indicate a different number of PUSCH transmissions/repetitions. Table 2B illustrates example values of the SRI/TCI field according to some embodiments of the present disclosure. In Table 2B, for example, W is an integer and 0≤W≤63. SRS resource(s) Y may include one or more SRS resources and TCI state(s) Z may include one or more TCI states.

TABLE 2B
Example values of the SRI/TCI field

| Value of the | |
|---|---|
| SRI/TCI field | Indicated information |
| W | At least one of: |
| | SRS resource(s) Y or TCI state(s) Z; |
| | PUSCH repetitions are disabled; and |
| | all of the SRS resource(s) Y or TCI state(s) Z are |
| | applied to one PUSCH transmission. |
| W + 1 | At least one of: |
| | SRS resource(s) Y or TCI state(s) Z; |
| | PUSCH repetitions are enabled; |
| | a subset of the SRS resource(s) Y or TCI state(s) Z |
| | is applied to one PUSCH transmission/repetition; and |
| | different PUSCH transmissions/repetitions are |
| | associated with different subsets of the SRS resource(s) |
| | Y or TCI state(s) Z. |

In some embodiments, there may be K values for the SRI or TCI field, where K is an integer and 1≤K≤8, for example, K ϵ {2, 4, 8}. In some embodiments, the K values may indicate same SRS resources or same TCI states. For example, the K values may indicate same SRS resource indices, same SRS resource set indices, a same number of SRS resources, and/or same TCI state indices. For example, each of the K values may also indicate a different number of transmission layers for a PUSCH. For another example, each of the K values may also indicate whether PUSCH repetitions are enabled or disabled.

For another example, each of the K values may also indicate a different number of PUSCH transmissions/repetitions. Table 2C illustrates example values of the SRI/TCI field according to some embodiments of the present disclosure. In Table 2C, for example, W is an integer and 0≤W≤63. SRS resource(s) Y may include one or more SRS resources and TCI state(s) Z may include one or more TCI states. For example, R and S are both integers, 1≤R≤16 and 1≤S≤16, and R≠S.

TABLE 2C
Example values of the SRI and/or TCI field

| Value of the SRI | |
|---|---|
| and/or TCI field | Indicated information |
| W | At least one of: |
| | SRS resource(s) Y or TCI state(s) Z; |
| | a subset of the SRS resource(s) Y or TCI state(s) Z |
| | is applied to one PUSCH transmission/repetition; and |
| | different PUSCH transmissions/repetitions are |
| | associated with different subsets of the SRS resource(s) |
| | Y or TCI state(s) Z; and |
| | the number of PUSCH repetitions is R. |
| W + 1 | At least one of: |
| | SRS resource(s) Y or TCI state(s) Z; |
| | a subset of the SRS resource(s) Y or TCI state(s) Z |
| | is applied to one PUSCH transmission/repetition; and |
| | different PUSCH transmissions/repetitions are |
| | associated with different subsets of the SRS resource(s) |
| | Y or TCI state(s) Z; and |
| | the number of PUSCH repetitions is S. |

Table 3 illustrates example values of the SRI field according to some embodiments of the present disclosure. In Table 3, up to three SRS resources (indexed with ‘0’, ‘1’ and ‘2’) associated with different beams or different spatial relation information are to be used for PUSCH transmissions.

TABLE 3
Example values of the SRI field

| Value of the SRI field | Indicated SRS resource(s) |
|---|---|
| 0 | SRS resource 0 |
| 1 | SRS resource 1 |
| 2 | SRS resource 2 |
| 3 | SRS resources 0 and 1 for two |
| | transmission layers of a PUSCH |
| 4 | SRS resources 0 and 2 for two |
| | transmission layers of a PUSCH |
| 5 | SRS resources 1 and 2 for two |
| | transmission layers of a PUSCH |
| 6 | SRS resources 0, 1 and 2 for three |
| | transmission layers of a PUSCH |
| 7 | SRS resources 0 and 1 for PUSCH repetitions |
| 8 | SRS resources 0 and 2 for PUSCH repetitions |
| 9 | SRS resources 1 and 2 for PUSCH repetitions |

Table 4 illustrates example values of the SRI field according to some embodiments of the present disclosure. In Table 4, up to four SRS resources (indexed with ‘0’, ‘1’, ‘2’ and ‘3’) associated with different beams or different spatial relation information are to be used for PUSCH transmissions.

TABLE 4
Example values of the SRI field

| Value of | |
|---|---|
| the SRI field | Indicated SRS resource(s) |
| 0 | SRS resource 0 |
| 1 | SRS resource 1 |
| 2 | SRS resource 2 |
| 3 | SRS resource 3 |
| 4 | SRS resources 0 and 1 for two |
| | transmission layers of a PUSCH |
| 5 | SRS resources 0 and 2 for two |
| | transmission layers of a PUSCH |
| 6 | SRS resources 0 and 3 for two |
| | transmission layers of a PUSCH |
| 7 | SRS resources 1 and 2 for two |
| | transmission layers of a PUSCH |
| 8 | SRS resources 1 and 3 for two |
| | transmission layers of a PUSCH |
| 9 | SRS resources 2 and 3 for two |
| | transmission layers of a PUSCH |
| 10 | SRS resources 0, 1 and 2 for three |
| | transmission layers of a PUSCH |
| 11 | SRS resources 0, 1 and 3 for three |
| | transmission layers of a PUSCH |
| 12 | SRS resources 0, 2 and 3 for three |
| | transmission layers of a PUSCH |
| 13 | SRS resources 1, 2 and 3 for three |
| | transmission layers of a PUSCH |
| 14 | SRS resources 1, 2, 3 and 4 for |
| | four transmission layers of a PUSCH |
| 15 | SRS resources 0 and 1 for PUSCH repetitions |
| 16 | SRS resources 0 and 2 for PUSCH repetitions |
| 17 | SRS resources 0 and 3 for PUSCH repetitions |
| 18 | SRS resources 1 and 2 for PUSCH repetitions |
| 19 | SRS resources 1 and 3 for PUSCH repetitions |
| 20 | SRS resources 2 and 3 for PUSCH repetitions |

In some embodiments, the network device 110 may transmit the configuration to the terminal device 120 via DCI. The DCI may include a plurality of SRI fields and a value of each SRI field may indicate a SRS resource or SRS resource set associated with a corresponding beam, corresponding spatial relation information or a corresponding set of QCL parameters to be applied to at least a part of the PUSCH repetitions. For example, if the number of the PUSCH repetitions is N_{r_pusch}, where N_{r_pusch} is a positive integer (for example, 1≤N_{r_pusch}≤16), and if the DCI includes a first SRI field and a second SRI field, the first SRI field may be applied to floor (N_{r_pusch}/2) or ceil (N_{r_pusch}/2) PUSCH repetitions and the second SRI field may be applied to remaining PUSCH repetitions.

In some embodiments, the network device 110 may transmit the configuration to the terminal device 120 via DCI. The DCI may include a transmission configuration indicator (TCI) field and a value of the TCI field (also referred to as “TCI codepoint”) may indicate a plurality of TCI states associated with different beams or different spatial relation information or different QCL parameters. The PUSCH repetitions may be transmitted from the terminal device 120 to the network device 110 via the different beams or based on the different spatial relation information. For example, if the number of the PUSCH repetitions is N_{r_pusch}, where N_{r_pusch} is a positive integer, for example, 1≤N_{r_pusch}≤16, and if one TCI codepoint indicates a first TCI state (or a first set of QCL parameters) and a second TCI state (or a second set of QCL parameters), the first TCI state (or the first set of QCL parameters) may be applied to floor (N_{r_pusch}/2) or ceil (N_{r_pusch}/2) PUSCH repetitions and the second TCI state (or the second set of QCL parameters) may be applied to remaining PUSCH repetitions.

In some embodiments, the physical channel may be a PUCCH and the configuration may indicate at least one of the following: whether PUCCH repetitions are enabled or not; a number of PUCCH repetitions; and at least one PUCCH resource to be used for the PUCCH repetitions. For example, the configuration may be transmitted from the network device 110 to the terminal device 120 via any of the following: RRC signaling, MAC CE or DCI.

In some embodiments, one PDCCH may schedule one PUCCH resource and the PUCCH resource may be configured with different spatial relation information, different QCL parameters and/or different TCI states to be applied to the PUCCH repetitions. For example, if the number of the PUCCH repetitions is N_{r_pucch}, where N_{r_pucch} is a positive integer (for example, 1≤N_{r_pucch}≤16), and the PUCCH resource for the PUCCH repetitions is associated with first spatial relation information and second spatial relation information, the first spatial relation information may be applied to floor (N_{r_pucch}/2) or ceil (N_{r_pucch}/2) PUCCH repetitions and the second spatial relation information may be applied to remaining PUCCH repetitions. For another example, if the number of the PUCCH repetitions is N_{r_pucch}, where N_{r_pucch} is a positive integer (for example, 1≤N_{r_pucch}≤16), and the PUCCH resource for the PUCCH repetitions is associated with a first TCI state (or a first set of QCL parameters) and a second TCI state (or a second set of QCL parameters), the first TCI state (or the first set of QCL parameters) may be applied to floor (N_{r_pucch}/2) or ceil (N_{r_pucch}/2) PUCCH repetitions and the second TCI state (or the second set of QCL parameters) may be applied to remaining PUCCH repetitions.

In some embodiments, the configuration for the PUCCH repetitions may also indicate a time interval between two adjacent PUCCH repetitions. The time interval may be M symbols, where M is an integer and 0≤M≤13. For example, M may be configured to the terminal device 120 via any of RRC signaling, MAC CE or DCI. For example, M may be 0 by default.

In some embodiments, one PDCCH may schedule Q PUCCH resources configured with different spatial relation information, different QCL parameters and/or different TCI states to be applied to the PUCCH repetitions, where Q is an integer and 1≤Q≤4. For example, Q=2. For example, if the number of the PUCCH repetitions is N_{r_pucch}, where N_{r_pucch} is a positive integer (for example, 1≤N_{r_pucch}≤16), and there are a first PUCCH resource and a second PUCCH resource for the PUCCH repetitions, the first PUCCH resource may be used for floor (N_{r_pucch}/2) or ceil (N_{r_pucch}/2) PUCCH repetitions and the second PUCCH resource may be used for remaining PUCCH repetitions. In some embodiments, the Q PUCCH resources may be used for transmissions of a same ACK/NACK feedback, same data, a same CSI feedback, a same L1-RSRP feedback and/or a same L1-SINR feedback.

In some embodiments, if PDCCH, PUSCH and/or PUCCH repetitions are enabled, the number of repetitions may be configured per TRP (beam/TCI state/QCL parameter/spatial relation information). For example, there may be X TRPs (for example, X beams, X TCI states, X QCL parameters or X spatial relation information configurations), where X is an integer and 1≤X≤4. For the i^{th} TRP (beam/TCI state/QCL parameter/spatial relation information), the number of repetitions may be Ni, where Ni is an integer and 1≤Ni≤4, and i is an integer and 1≤i≤X For different TRPs or beams, respective numbers of repetitions may be different. For example, if i≠j, Ni≠Nj, where i and j are both integers, 1≤i≤X and 1≤j≤X In some embodiments, the number of repetitions per TRP (beam/TCI state/QCL parameter/spatial relation information) may be configured to the terminal device 120 via any of RRC signaling, MAC CE or DCI.

FIG. 8 illustrates a flowchart of an example method 800 in accordance with some embodiments of the present disclosure. The method 800 can be performed at the terminal device 120 as shown in FIG. 1A, FIG. 1B and/or FIG. 2. It is to be understood that the method 800 may include additional blocks not shown and/or may omit some blocks as shown, and the scope of the present disclosure is not limited in this regard.

At block 810, the terminal device 120 receives, from the network device 110, a configuration about repetitions for a physical channel between the network device 110 and the terminal device 120. At block 820, the terminal device 120 communicates the repetitions for the physical channel with the network device 110 based on the configuration.

In some embodiments, the configuration may be received from the network device 110 via any of the following: RRC signaling, MAC CE or DCI.

In some embodiments, the physical channel may be a PDCCH and the configuration may indicate at least one of the following: whether PDCCH repetitions are enabled or not; a number of PDCCH repetitions; at least one CORESET to be used for the PDCCH; and whether the PDCCH repetitions are used for scheduling transmissions of same data or same control information.

In some embodiments, the configuration may indicate a CORESET with a plurality of sets of QCL parameters, and each set of QCL parameters is to be applied to at least a part of the PDCCH repetitions.

In some embodiments, the configuration may indicate a plurality of CORESETs, and each CORESET is to be applied to at least a part of the PDCCH repetitions.

In some embodiments, the physical channel may be a PUSCH and the configuration may indicate at least one of the following: whether PUSCH repetitions are enabled or not; a number of PUSCH repetitions; and a maximum number of layers for each PUSCH repetition.

In some embodiments, the configuration may be received from the network device 110 via DCI. The DCI may comprise an SRI field and a value of the SRI field may indicate different spatial relation information to be applied to the PUSCH repetitions.

In some embodiments, the configuration may be received from the network device 110 via DCI. The DCI may comprise a plurality of SRI fields and a value of each SRI field may indicate spatial relation information to be applied to at least a part of the PUSCH repetitions.

In some embodiments, the configuration may be received from the network device 110 via DCI. The DCI may comprise a plurality of TCI fields and a value of each TCI field may indicate spatial relation information to be applied to at least a part of the PUSCH repetitions.

In some embodiments, the physical channel may be a PUCCH and the configuration may indicate at least one of the following: whether PUCCH repetitions are enabled or not; a number of PUCCH repetitions; and at least one PUCCH resource to be used for the PUCCH repetitions.

In some embodiments, the configuration may indicate a PUCCH resource associated with different spatial relation information to be applied to the PUCCH repetitions.

In some embodiments, the configuration may indicate a plurality of PUCCH resources associated with different spatial relation information, and each PUCCH resource may be used for at least a part of the PUCCH repetitions.

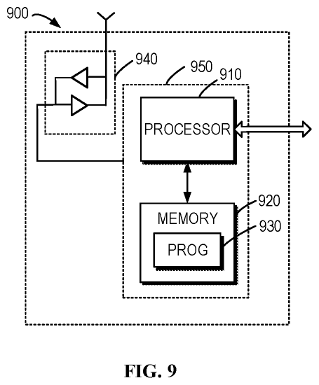

FIG. 9 is a simplified block diagram of a device 900 that is suitable for implementing embodiments of the present disclosure. The device 900 can be considered as a further example implementation of the network device 110, the terminal device 120 or the TRP 130 as shown in FIG. 1A and/or FIG. 1B. Accordingly, the device 900 can be implemented at or as at least a part of the network device 110, the terminal device 120 or the TRP 130 as shown in FIG. 1A and/or FIG. 1B.

As shown, the device 900 includes a processor 910, a memory 920 coupled to the processor 910, a suitable transmitter (TX) and receiver (RX) 940 coupled to the processor 910, and a communication interface coupled to the TX/RX 940. The memory 910 stores at least a part of a program 930. The TX/RX 940 is for bidirectional communications. The TX/RX 940 has at least one antenna to facilitate communication, though in practice an

Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 930 is assumed to include program instructions that, when executed by the associated processor 910, enable the device 900 to operate in accordance with the embodiments of the present disclosure, as discussed herein with reference to FIGS. 1A to 8. The embodiments herein may be implemented by computer software executable by the processor 910 of the device 900, or by hardware, or by a combination of software and hardware. The processor 910 may be configured to implement various embodiments of the present disclosure. Furthermore, a combination of the processor 910 and memory 920 may form processing means 950 adapted to implement various embodiments of the present disclosure.

The memory 920 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 920 is shown in the device 900, there may be several physically distinct memory modules in the device 900. The processor 910 may be of any type suitable to the local technical network, and may include one or more of general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIG. 2, FIG. 5, FIG. 6, FIG. 7 and/or FIG. 8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method of communication, comprising:
generating, at a network device, downlink control information (DCI) indicating a plurality of transmission power control (TPC) commands for power control of transmissions from a terminal device to the network device; and
transmitting, from the network device to the terminal device, the generated DCI for scheduling the transmissions from the terminal device to the network device.

2. The method of claim 1, wherein generating the DCI comprises:
generating the DCI comprising a plurality of fields for indicating the plurality of TPC commands.

3. The method of claim 1, wherein generating the DCI comprises:
generating the DCI comprising an SRS resource indicator (SRI) field or a transmission configuration indicator (TCI) field for indicating the plurality of TPC commands.

4. The method of claim 1, wherein generating the DCI comprises:
generating a plurality of repetitions of the DCI, the plurality of repetitions indicating the plurality of TPC commands respectively.

5. The method of claim 1, wherein the transmissions scheduled by the generated DCI comprise Physical Uplink Shared Channel (PUSCH) transmissions or Physical Uplink Control Channel (PUCCH) transmissions.

6. A method of communication, comprising:
receiving, at a terminal device and from a network device, downlink control information (DCI) indicating a plurality of transmission power control (TPC) commands for power control of transmissions from the terminal device to the network device;
determining the plurality of TPC commands from the DCI; and
performing the transmissions from the terminal device to the network device while controlling power of the transmissions based on the plurality of TPC commands.

7. The method of claim 6, wherein the DCI comprises a plurality of fields for indicating the plurality of TPC commands, and determining the plurality of TPC commands from the DCI comprises:
determining the plurality of TPC commands from the plurality of fields in the DCI.

8. The method of claim 6, wherein the DCI comprises an SRS resource indicator (SRI) field or a transmission configuration indicator (TCI) field for indicating the plurality of TPC commands, and determining the plurality of TPC commands from the DCI comprises:
determining the plurality of TPC commands from the SRI field or the TCI field in the DCI.

9. The method of claim 6, wherein
receiving the DCI comprises:
receiving a plurality of repetitions of the DCI from the network device; and
determining the plurality of TPC commands from the DCI comprises:
determining the plurality of TPC commands from the plurality of repetitions respectively.

10. The method of claim 6, wherein the transmissions comprise Physical Uplink Shared Channel (PUSCH) transmissions or Physical Uplink Control Channel (PUCCH) transmissions.

11. The method of claim 6, wherein controlling power of the transmissions based on the plurality of TPC commands comprises:
determining, from the plurality of TPC commands, a TPC command to be used for controlling power of a transmission of the transmissions;
determining a power control adjustment state corresponding to the TPC command; and
controlling power of the transmission based on the power control adjustment state and the TPC command.

12. A method of communication, comprising:
transmitting, from a network device to a terminal device, a configuration about repetitions for a physical channel between the network device and the terminal device; and
communicating the repetitions for the physical channel with the terminal device based on the configuration.

13. The method of claim 12, wherein the configuration is transmitted to the terminal device via any of the following:
Radio Resource Control (RRC) signaling;
Medium Access Control (MAC) control element (CE); and
Downlink Control Information (DCI).

14. The method of claim 12, wherein the physical channel is a PDCCH and the configuration indicates at least one of the following:
whether PDCCH repetitions are enabled or not;
a number of PDCCH repetitions;
at least one control resource set (CORESET) to be used for the PDCCH; and
whether the PDCCH repetitions are used for scheduling transmissions of same data or same control information.

15. The method of claim 14, wherein the configuration indicates a CORESET with a plurality of sets of quasi co-location (QCL) parameters, and each set of QCL parameters is to be applied to at least a part of the PDCCH repetitions.

16. The method of claim 14, wherein the configuration indicates a plurality of CORESETs, and each CORESET is to be applied to at least a part of the PDCCH repetitions.

17. The method of claim 12, wherein the physical channel is a PUSCH and the configuration indicates at least one of the following:
whether PUSCH repetitions are enabled or not;
a number of PUSCH repetitions; and
a maximum number of layers for each PUSCH repetition.

18. The method of claim 17, wherein the configuration is transmitted to the terminal device via DCI, the DCI comprises an SRS resource indicator (SRI) field and a value of the SRI field indicates different spatial relation information to be applied to the PUSCH repetitions.

19. The method of claim 17, wherein the configuration is transmitted to the terminal device via DCI, the DCI comprises a plurality of SRI fields and a value of each SRI field indicates spatial relation information to be applied to at least a part of the PUSCH repetitions.

20. The method of claim 17, wherein the configuration is transmitted to the terminal device via DCI, the DCI comprises a transmission configuration indicator (TCI) field and a value of the TCI field indicates different spatial relation information to be applied to the PUSCH repetitions.

21. The method of claim 12, wherein the physical channel is a PUCCH and the configuration indicates at least one of the following:
whether PUCCH repetitions are enabled or not;
a number of PUCCH repetitions; and
at least one PUCCH resource to be used for the PUCCH repetitions.

22. The method of claim 21, wherein the configuration indicates a PUCCH resource associated with different spatial relation information to be applied to the PUCCH repetitions.

23. The method of claim 21, wherein the configuration indicates a plurality of PUCCH resources associated with different spatial relation information, and each PUCCH resource is to be used for at least a part of the PUCCH repetitions.

24. A method of communication, comprising:
receiving, at a terminal device and from a network device, a configuration about repetitions for a physical channel between the network device and the terminal device; and
communicating the repetitions for the physical channel with the network device based on the configuration.

25. The method of claim 24, wherein the configuration is received from the network device via any of the following:
Radio Resource Control (RRC) signaling;
Medium Access Control (MAC) control element (CE); and
Downlink Control Information (DCI).

26. The method of claim 24, wherein the physical channel is a PDCCH and the configuration indicates at least one of the following:
whether PDCCH repetitions are enabled or not;
a number of PDCCH repetitions;
at least one control resource set (CORESET) to be used for the PDCCH; and
whether the PDCCH repetitions are used for scheduling transmissions of same data or same control information.

27. The method of claim 26, wherein the configuration indicates a CORESET with a plurality of sets of quasi co-location (QCL) parameters, and each set of QCL parameters is to be applied to at least a part of the PDCCH repetitions.

28. The method of claim 26, wherein the configuration indicates a plurality of CORESETs, and each CORESET is to be applied to at least a part of the PDCCH repetitions.

29. The method of claim 24, wherein the physical channel is a PUSCH and the configuration indicates at least one of the following:
whether PUSCH repetitions are enabled or not;
a number of PUSCH repetitions; and
a maximum number of layers for each PUSCH repetition.

30. The method of claim 29, wherein the configuration is received from the network device via DCI, the DCI comprises an SRS resource indicator (SRI) field and a value of the SRI field indicates different spatial relation information to be applied to the PUSCH repetitions.

31. The method of claim 29, wherein the configuration is received from the network device via DCI, the DCI comprises a plurality of SRI fields and a value of each SRI field indicates spatial relation information to be applied to at least a part of the PUSCH repetitions.

32. The method of claim 29, wherein the configuration is received from the network device via DCI, the DCI comprises a plurality of transmission configuration indicator (TCI) fields and a value of each TCI field indicates spatial relation information to be applied to at least a part of the PUSCH repetitions.

33. The method of claim 24, wherein the physical channel is a PUCCH and the configuration indicates at least one of the following:
whether PUCCH repetitions are enabled or not;
a number of PUCCH repetitions; and
at least one PUCCH resource to be used for the PUCCH repetitions.

34. The method of claim 33, wherein the configuration indicates a PUCCH resource associated with different spatial relation information to be applied to the PUCCH repetitions.

35. The method of claim 33, wherein the configuration indicates a plurality of PUCCH resources associated with different spatial relation information, and each PUCCH resource is to be used for at least a part of the PUCCH repetitions.

36. A network device, comprising:
a processor; and
a memory coupled to the processor and storing instructions thereon, the instructions, when executed by the processor, causing the network device to perform the method according to any of claims 1 to 5.

37. A terminal device, comprising:
a processor; and
a memory coupled to the processor and storing instructions thereon, the instructions, when executed by the processor, causing the terminal device to perform the method according to any of claims 6 to 11.

38. A network device, comprising:
a processor; and
a memory coupled to the processor and storing instructions thereon, the instructions, when executed by the processor, causing the network device to perform the method according to any of claims 12 to 23.

39. A terminal device, comprising:
a processor; and
a memory coupled to the processor and storing instructions thereon, the instructions, when executed by the processor, causing the terminal device to perform the method according to any of claims 24 to 35.

40. A computer readable medium having instructions stored thereon, the instructions, when executed on at least one processor, causing the at least one processor to perform the method according to any of claims 1 to 5.

41. A computer readable medium having instructions stored thereon, the instructions, when executed on at least one processor, causing the at least one processor to perform the method according to any of claims 6 to 11.

42. A computer readable medium having instructions stored thereon, the instructions, when executed on at least one processor, causing the at least one processor to perform the method according to any of claims 12 to 23.

43. A computer readable medium having instructions stored thereon, the instructions, when executed on at least one processor, causing the at least one processor to perform the method according to any of claims 24 to 35.
